(19) United States
(12) Patent Application Publication
(10) Pub. No.: US 2007/0078538 A1
(43) Pub. Date: Apr. 5, 2007

(54) Debug device

(75) Inventors: Yukihiro Kawakami, Ohtsu-shi (JP); Yutaka Abe, Moriyama-shi (JP); Ken Tsutsui, Yokohama-shi (JP); Koji Yaoita, Tokyo-to (JP); Takahisa Hasegawa, Kawasaki-shi (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 11/529,566

(22) Filed: Sep. 29, 2006

(30) Foreign Application Priority Data
Sep. 30, 2005 (JP) 2005-289404
Sep. 30, 2005 (JP) 2005-289405

(51) Int. Cl. G05B 19/42

(52) U.S. Cl. 700/87; 700/86

(57) ABSTRACT

The present invention aims to provide a debug device for efficiently and smoothly performing the debugging process of the control program including function blocks. In the debug device for executing each step configuring the control program including the function blocks one step at a time, a step-over function for continuously executing the program in the function block, and moving the executing position to the step after the execution of the function program in the control program when the next executing position is the function block (FIG. A); a step-in function for having the head position of the program in the function block as the next executing position when the next executing position is the function block; and a step-out function for continuously executing from the next executing position to the end of the function block and moving the executing position to the step after the execution of the function block when the next executing position is the step of the program in the function block are provided.

### BACKGROUND OF THE INVENTION

This application claims priority from Japanese patent applications 2005-289404, filed Sep. 30, 2005, and 2005-289405, filed Sep. 30, 2005. The entire content of the aforementioned application is incorporated herein by reference.

1. Field of the Invention

The present invention relates to a debug device for control program including function blocks.

2. Description of the Related Art

In the development of the control program of the programmable controller (hereinafter referred to as “PLC”), the language corresponding to the development object can be used through various languages of IEC-61131-3. In the development stage, the debug process generally using the debug device is performed to verify and check the operation of the designed control program. The debug device includes a simulator for executing the control program in place of the actual PLC equipment and a controlling section for controlling the operation of the simulator.

The control of the relevant operation may be a step execution for executing the command of the control program one step (one command) at a time every time the input of the execution command is received, a scan execution for executing the entire control program once or repeatedly until a stop command is sent etc. The control may be setting a brake point at an arbitrary location of the control program in advance, and suspending the execution of the program when the position of the brake point is reached during the execution of the program. Thus, determination on whether or not the program is properly operating as designed, or if a problem occurs, specification and correction of the location where the problem has occurred are performed by executing or stopping the program with an appropriate method and checking the state of the program execution result at the time by means of a display screen. A relevant debug device is disclosed in the Japanese patent publication of No. 2001-067245.

### SUMMARY OF THE INVENTION

One element configuring the program defined in IEC-61131-3 is the function block. One description purpose of the function block is to facilitate the design and maintenance caused by reduction in the displaying program amount due to hiding of the program. The method of realizing the function block is created through a concept called instance. Therefore, one entity of the function block exists, one or a plurality of instances are described on the main control program, and when the executing position of the program reaches such described position of the relevant function block, each command described in the entity of the above function block is sequentially executed as if a sub-routine program and after the last command is executed, the program again returns to the original position and the next command on the main program is executed.

Therefore, when the step execution is selected in time of debugging, execution is always performed one step at a time even for the inside of the function, and thus the task is complicating and inefficient. In particular, in a case of the program described with the function block, the program in the function block is most likely to be completed, and thus the necessity to verify and debug the program configuring the function block while debugging the entire main control program is small. Furthermore, the same function block is sometimes used over a plurality of times during one main control program, in which case, the execution is performed one step at a time each time the instance of the function block of the same content appears, and thus is complicating.

Furthermore, setting the brake point inside the function block is difficult. In other words, since the method of realizing the function block is created through the concept of instance, the execution is suspended at the set brake point in the instances of all the function blocks when the brake point is simply set at a step of a certain position of the program configuring the function block since only one entity of the program of the function block exists even if the same function block is used over a plurality of times on the control program.

For example, assume a program for controlling a robot with the function block, where the program is used in controlling two robots A and B. Although a request is made to the robot A to suspend at the brake point set at a certain position but not to suspend to the robot B, execution is suspended at the set brake point even during the execution of the program of the function for the control of the robot B and thus the request cannot be responded.

A request to set the brake point at different positions for the robot A and the robot B may be made, but if the brake point is set at two positions, the execution is suspended at the positions of the two brake points in time of the control execution of the robot A and in time of the control execution of the robot B, and thus the relevant request cannot be responded.

The present invention aims to provide a debug device for efficiently and smoothly performing the debug process of the control program including function blocks. Furthermore, the present invention also aims to provide a debug device capable of setting a practicable brake point even in the function block.

In order to achieve the above aim, the debug device according to the present invention is a debug device for control program including function blocks; the debug device including a one step executing section for executing each step configuring the control program one step at a time; a step-over executing section for executing a step-over of continuously executing the program in the function block, and moving the executing position to the step after the execution of the function program in the control program when the next executing position by the one step executing section is the function block; and a step-in executing section for executing step-in of having the head position of the program in the function block as the next executing position when the next executing position by the one step executing section is the function block.

In the present invention, two functions of the step-over executing section and the step-in executing section are provided, so that the user is able to select either to enter the function block and verify while performing the step execution when the step execution position reaches the head of the function block (step-in), or to continuously execute the relevant function block without entering the function block and proceed to the next step (step-over), whereby an appropriate process corresponding to the situation can be efficiently performed.

A step-out executing section is further provided for executing a step out of continuously executing from the next executing position to the end of the function block and moving the executing position to the step after the execution of the function block when the next executing position by the one step executing section is the step of the program in the function block.

Therefore, by providing the step-out executing section, the process once enters the function block by the step-in, performs the step execution and verification up to the necessary location, and thereafter performs continuous execution. Thus, the task of providing the one step execution command for each step after the relevant necessary location can be omitted, whereby the workability is further enhanced.

The control program is a program of layered structure with a function block (child) described in the function block; and the program in the function block is executed one step at a time by the one step executing section, and when the next executing position is the function block (child), the head position of the program in the function block (child) is set as the next executing position and the function block (child) is one step executed if the step-in executing section is operated.

The control program is a program of layered structure with a function block (child) described in the function block; and the program in the function block is executed one step at a time by the one step executing section, and when the next executing position is the function block (child), the head position of the program in the function block (child) is set as the next executing position, and the function block (child) is one step executed if the step-in executing section is operated; and when the next position by the one step executing section is the step of the program in the function block (child), continuous execution is performed from the next executing position to the end of the function block (child), and the executing position is moved to the step after the execution of the function block (child) in the program of the function block if the step-out executing section is operated.

The control program is a program of layered structure with a function block (child) described in the function block; and the program in the function block is executed one step at a time by the one step executing section, and when the next executing position is the function block (child), the program in the function block (child) is continuously executed, and the executing position is moved to the step after the execution of the function block (child) in the function block if the step-over executing section is operated.

The above described “function block (child)” means a section being a relative low order layer of one layer in relation to the “function block”. Therefore, when the function block B is present in the function block A, and the function block C is present in the function block B, the function block A is the “function block” and the function block B is the “function block (child) in the relationship between the function block A and the function block B. Furthermore, the function block B is the “function block” and the function block C is the “function block (child) in the relationship between the function block B and the function block C.

A storage section for storing break point management information associating program identifying information for specifying the function block described in the control program, and the step position information for suspension in the program in the function block; and a suspension section for determining whether or not the currently executing step is the step position of the function block specified with the break point management information stored in the storage section based on the break point management information stored in the storage section during the continuous execution of the function block, and suspending the program execution when relevant are further arranged. The program identifying information includes, for example, instance identifying information of the function block. The break point management information corresponds to the break point management table in the embodiment.

Therefore, even if a plurality of instances of the same function block are present in the control program, each instance can be specified, and the step position for suspension can be defined for each instance. Thus, the process may be continuously executed without being suspended at a certain instance of the function block, and be suspended at another instance even in the same function block. Furthermore, the position for suspension can be set unique for each instance, and thus the workability enhances.

In order to achieve the aim of providing a debug device capable of setting a practicable break point even in the function block, the debug device according to the present invention is a debug device for control program including a function block; the debug device including a program executing section for continuously executing the steps configuring the control program; a storage section for storing break point management information associating program identifying information for specifying the function block described in the control program and step position information for suspension in the program in the function block; and a section for determining whether or not the currently executing step is the step position of the function block specified with the break point management information stored in the storage section based on the break point management information stored in the storage section during the continuous execution of the function block by the program executing section, and suspending the program execution when relevant. The program identifying information contains instance identifying information of the function block. Other information may be further added or may be the information other than the instance identifying information (information for specifying the corresponding instance). The break point management information corresponds to the break point management table in the embodiment.

Therefore, even if a plurality of instances of the same function block are present in the control program, each instance can be specified, and the step position for suspension can be defined for each instance. Thus, the process may be continuously executed without being suspended at a certain instance of the function block, and be suspended at another instance even in the same function block. Furthermore, the position for suspension can be set unique for each instance, and thus the workability enhances.

The storage section stores break point management information associating, with respect to a step outside the function block, program identifying information for specifying the step and the step position of the step; and the suspension section suspends the program execution when relevant for the step outside the function block. According to the relevant configuration, the break points can be managed with the same system configuration regardless of whether inside or outside the function block, and thus is preferable.

In the present invention, functions such as step-in, step-over and the like are provided, whereby the debugging process of the control program including the function block can be efficiently and smoothly performed by making full use of the functions according to the situation. Furthermore, since the step position (break point) for suspension is set for each instance of the individual function block, the practicable setting of the break point can be performed even in the function block.

### BRIEF DESCRIPTION OF THE DRAWINGS

FIG. 1 shows a block diagram showing a preferred embodiment of the present invention;

FIG. 2 shows a view showing one example of an operation screen;

FIGS. 3A, 3B and 3C show views explaining a function block;

FIG. 4 shows a view explaining the function block;

FIGS. 5A, 5B and 5C show conceptual views for explaining step-over, step-in, and step-out;

FIG. 6 shows a flow chart illustrating the function of a program control unit;

FIGS. 7A, 7B and 7C show views explaining step-over, step-in, and step-out when a function block is described in the function block;

FIG. 8 shows a view showing one example of a data structure of a brake point management table;

FIG. 9 shows a flow chart illustrating the registration function of a brake point of the program control unit;

FIGS. 10A and 10B show views explaining the operation of the registration of the brake point;

FIG. 11 shows a flow chart illustrating the brake processing function of the program execution unit;

FIGS. 12A and 12B show views explaining the operation of the registration of the brake point; and

FIG. 13 shows a flow chart illustrating the brake processing function of the program execution unit.

### DETAILED DESCRIPTION OF THE PREFERRED EMBODIMENTS

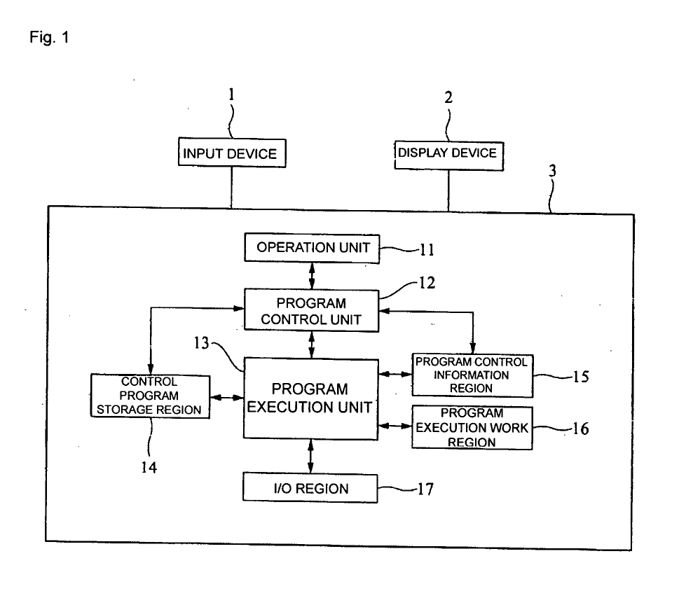

FIG. 1 shows one embodiment of the debug device according to the present invention. The debug device is configured by installing an application program to a computer such as personal computer. Therefore, an input device 1 such as keyboard, pointing device and the like, a display device 2, and a device main body (CPU main body) 3 are arranged as the hardware configuration, as shown in FIG. 1. The device main body 3 includes an operation unit 11, a program control unit 12, a program execution unit 13, a control program storage region 14, a program control information region 15, a program execution work region 16, and an I/O region 17. The operation unit 11, the program control unit 12 and the program execution unit 13 are realized with the application program executed on the CPU. The control program storage region 14, the program control information region 15, the program execution work region 16, and the I/O region 17 are realized by various storage section such as RAM, hard disc etc.

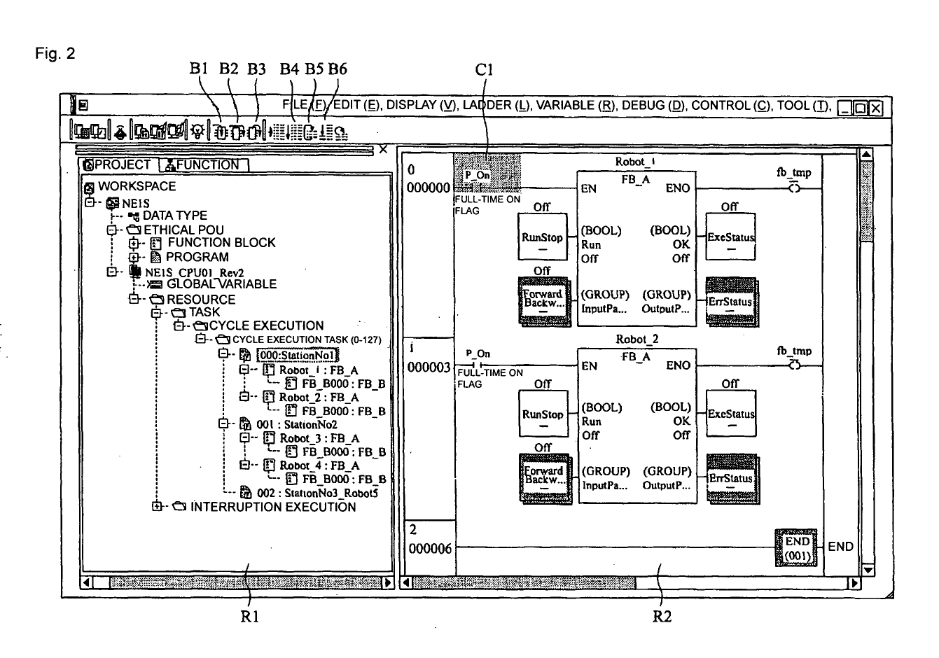

The operation unit 11 outputs the operation screen for performing the debugging of the control program to the display device 2, receives the input from the input device 1, and sends the received input to the program control unit 12. FIG. 2 shows one example of the operation screen. The arrangement layout of the operation screen has various execution operation buttons B1, B2, B3, B4, B5, B6, for providing execution command of the control program arranged on the upper part of the screen, a project tree display region R1 displaying the program configuration arranged on the left side, and a program display region R2 displaying the control program to be debugged arranged on the right side. In the program display region R2, a rectangular cursor C1 indicating the step (command) currently being executed is displayed. As hereinafter described, the cursor C1 is also used in specifying the step position for setting the brake point. The execution operation buttons B1, B2, B3 are operation buttons used in the step execution. The operation buttons are buttons on the display screen and are operated by the input signal and the like through clicking of the mouse. In place of the screen buttons, it may be configured so as to be operated by the input signal and the like by the key of the keyboard or the function key of the personal computer.

The One Scan Execution

The operation button B4 provides a command to continuously execute the control program only once (one scan) from the beginning to the end. The continuous execution operation button B5 provides a continuous execution command to repeatedly execute the control program. The execution stop button B6 provides a command to stop the program execution that is being continuously executed when the continuous execution operation button B5 is pushed (clicked).

The program control unit 12 performs the processes of determining the execution step based on the execution command received from the operation unit 11, requesting the execution of the determined execution step to the program execution unit 13, creating a brake point management table for managing the brake point with the set positions of the brake command received from the operation unit 11, and storing the same in the program control information region 15.

The program execution unit 13 executes or stops the control program with the request from the program control unit 12 and the program control information (brake point management table in the present embodiment) set by the program control unit 12.

The control program storage region 14 is a storage area for storing the control program of PLC, and is set as a predetermined region of the memory. The program execution unit 13 reads and executes the control program stored in the control program storage region 14.

The program control information region 15 is a storage area for storing the program control information such as the brake point management table created in the program control unit 12, and is set as a predetermined region of the memory.

The program execution work region 16 is a storage area that corresponds to the internal memory of the PLC and that becomes the work memory used when the program execution unit 13 executes the control program, and is set as a predetermined region of the RAM. The I/O region 17 is a storage area corresponding to the I/O memory of the PLC and is set as a predetermined region of the RAM.

The control program executed by the program execution unit 13 is a program that includes function blocks and described with the ladder program as displayed in the program display region R2 of FIG. 2 in the present embodiment. In the case of the control program shown in FIG. 2, the program (FB_A) created by the function has Robot_1 and Robot_2 in the program Station No. 1 and Robot_3 and Robot_4 in the program Station No. 2 used as the instances and performs the control of the respective equipment.

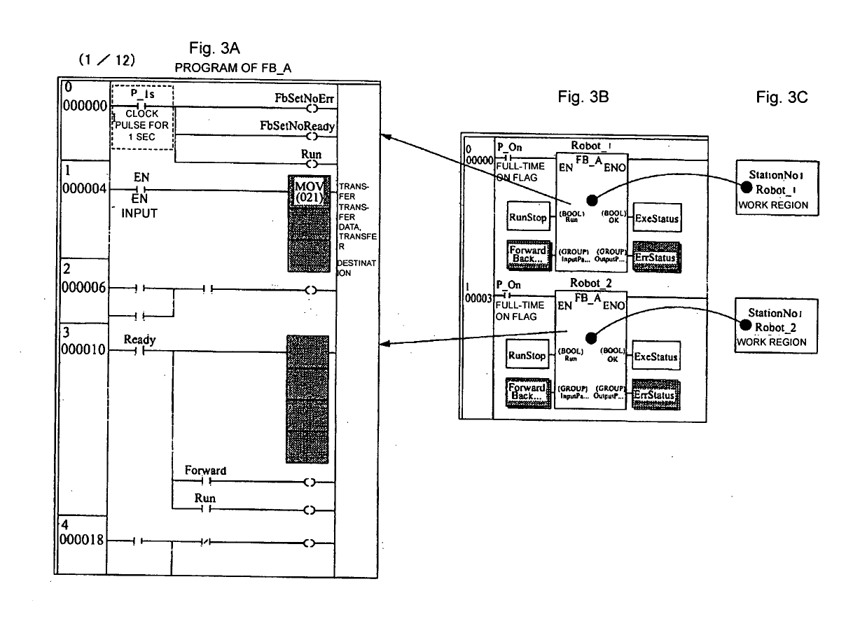

FIG. 3A shows one part of the program of the function block (FB_A). As shown in FIG. 3B, when the rectangular box corresponding to the function block is described in the control program, each command of the control program shown in FIG. 3B is sequentially executed and when the function block is reached, the program in the function block shown in FIG. 3A is executed to the end, and then the next command of the function block shown in FIG. 3B is executed.

In FIG. 3B, the control of Robot_1 and Robot_2 is performed in the function block (FB_A). Robot_1 and Robot_2, which are the instances of the same function block (FB_A), each have the work region (see FIG. 3C) set in the program execution work region 16, and the Robot to be controlled is controlled by individually providing the input data. Since the work regions are respectively set in the above manner, the I/O data etc. differs, and thus the control corresponding to the respective controlling target can be performed even if the program of the same function block is executed.

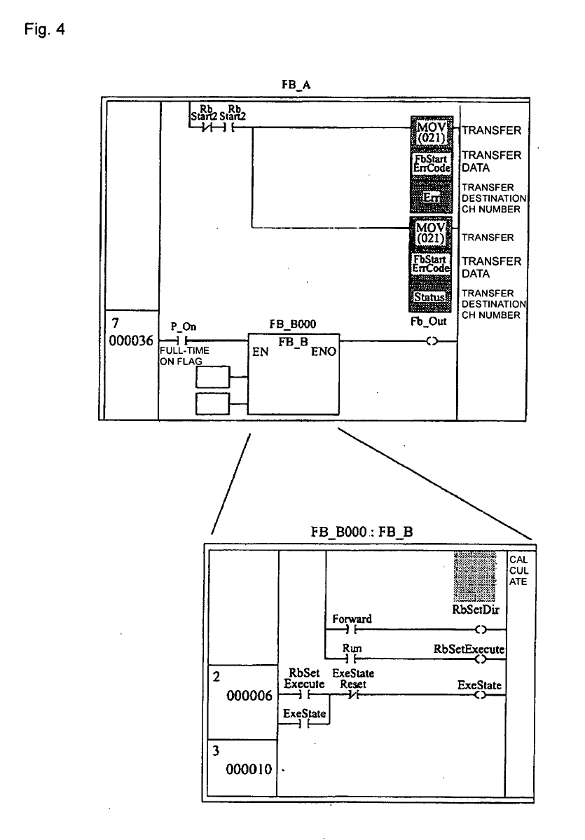

As shown in FIG. 4, the function block (FB_B) may be described in the program configuring the function block (FB_A). Thus, the function block may be performed with multi-layer configuration description.

In the present embodiment, the program control unit 12 has three functions of “step-over”, “step-in”, and “step-out” as functions in the step execution. The three functions are all used in the execution related to the function block.

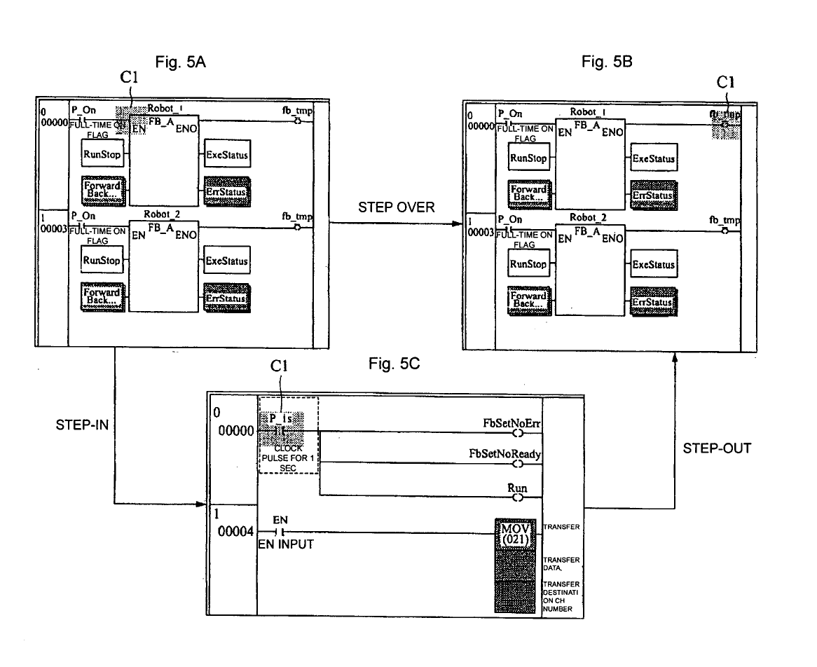

As shown in FIG. 5A, the step-over is for continuously executing the inside of the function block when the cursor Cl indicating the command (current step position) to execute is at the beginning of the function block, and proceeding to the next step (see FIG. 5B). In other words, the command for executing the step-over is a command for executing the function block as one step. Thus, the process for step executing each command in the function block may be omitted, and the debug work is efficiently performed. This is an effective function when the function block does not need to be debugged.

The step-in is for proceeding to the first step in the function block when the cursor C1 indicating the command (current step position) to execute is at the beginning of the function block (see FIG. 5C). In other words, the command for executing the step-in is a command for stopping at the beginning step in the function block. Thus, the program in the function block can be step executed. This is also an effective function when verifying the program in the function block.

The step-out is for entering the function block by executing the step-in once, continuously executing the remaining steps in the function block when step executing one command at a time, and proceeding to the step after the execution of the function block on the function block calling side. The command for executing the step-out is a command for continuously executing the remaining steps in the function block and stopping at the next step of the function block of the function block calling originator. By step executing the inside of the function block and verifying part way, the task of step executing one step at a time thereafter is omitted if the verification of the subsequent commands is not required.

Providing two functions of step-over and step-in, the user is able to choose whether to enter the inside of the function block and perform verification while performing step execution (step in), or to continuously execute the relevant function block without entering the function block and proceeding to the next step (step over) when reaching the beginning of the function block, thereby efficiently performing a suitable process according to the situation.

Furthermore, by providing the step-out, the step execution and verification are performed up to the necessary location for the inside of the function block and thereafter continuously executed, and thus the task of inputting one step execution command for all the steps in the function block is omitted, and the workability is further enhanced.

In the present embodiment, the above described three functions and the normal step execution are executed with three execution operation buttons B1, B2, B3. That is, B1 is the step-in button. When the step-in button B1 is pushed at the beginning of the function, the process proceeds to the first step in the function block. That is, the above-described step-in function is executed. When the step-in button B1 is pushed other than at the beginning of the function block, that is, the normal command or at the inside of the function block, one step execution is performed.

B2 is the step-over button. When the step over button B2 is pushed at the beginning of the function block, the inside of the function block is continuously executed. That is, the above-described step-over function is executed. When the step-over button B2 is pushed other than at the beginning of the function block, that is, the normal command or at the inside of the function block, one step execution is performed.

B3 is the step-out button. When the step-put button B3 is pushed either at the beginning of the function block or in the middle of the function block, the remaining programs in the function block are continuously executed. When the step-out button B3 is pushed at the position of the normal command outside the function block, one step execution is performed.

In other words, all of the three buttons B1, B2, B3 refers to the command for one step execution at the position of the normal command outside the function block. Obviously, in the present embodiment, input of four types of commands, three functions and the command of the normal one step execution, are possible with three buttons B1, B2, B3, but the present invention is not limited thereto, and a button for the command input of one step execution may be arranged, the step-over and step-out may be commonly used so as to be realized with two buttons, and thus various realizing methods can be adopted. In the latter case of commonly using the button, the step-over is executed when the commonly used button is pushed at the head position of the function block and the step-out is executed when the commonly used button is pushed inside the function block.

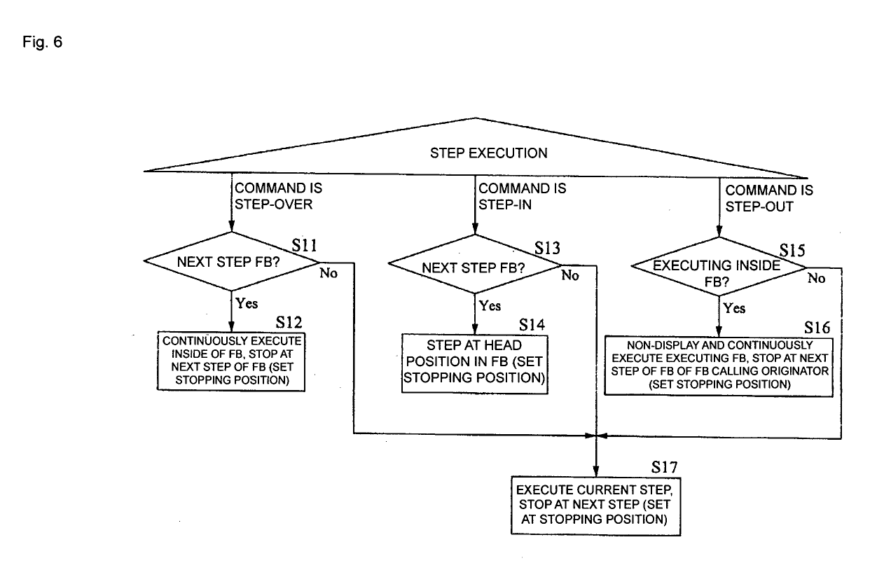

FIG. 6 is a flow chart illustrating the function of the program control part 12 for performing the three functions and the one step execution. The program control part 12 determines the execution step (stop step) based on the execution command (push B1, B2, B3) received from the operation part 11, and provides the execution request of a predetermined step of the control program to the program execution part 13 based on the determined content.

This flow chart operates in time of the one step execution mode. That is, the one step execution mode is when a continuous execution involved in pushing of the one scan execution operation button B4 or the continuous execution operation button B5 is not performed in the operation screen shown in FIG. 2.

In the one step execution mode, one of the step-in button B1, the step-over button B2, or the step-out button B3 is waited to be pushed (input command). When the step-over button B2 is pushed, determination is made on whether or not the next step is the function block (S11). Specifically, determination is made on whether or not the cursor C1 is at the head position of the function block as shown in FIG. 5A. If the next step is the function block (Yes in S11), the inside of the function block is continuously executed, and the stopping position is set so as to stop at the next step of the function block (S12). Based thereon, the program execution part 13 continuously executes the inside of the function block. The cursor C1 proceeds to the next step of the function block, which is the stopping position.

When the step-in button B1 is pushed while waiting for the command input, determination is made on whether or not the next step is the function block (S13). If the next step is the function block (Yes in S13), the stopping position is set so as to stop at the beginning step in the function block (S14). In response thereto, the program execution unit 13 skips to the beginning step in the function block. The operation unit 11 displays the program of the function block on the program display region R2 and positions the cursor C1 at the beginning step of the displayed function block.

When the step-out button B3 is pushed while waiting for the command input, determination is made on whether or not the inside of the function block is being executed (S15). This can be determined by whether or not the cursor C1 is positioned at the step (irrespective of at the beginning or not) configuring the program of the function block. In a case of executing the function block (Yes in S15), the stopping position is set so as to stop at the next step in the function block of the function block calling originator (S16). Based thereon, the program execution unit 13 continuously executes the steps in the function block after the current step. The cursor C1 proceeds to the next step of the function block, which is the stopping position.

Regardless of which command is input, one step execution is performed if the determination result of each branching determinations S11, S13, S15 is NO (S17). That is, the program execution unit 13 executes the current step where the cursor C1 is placed and stops at the next step.

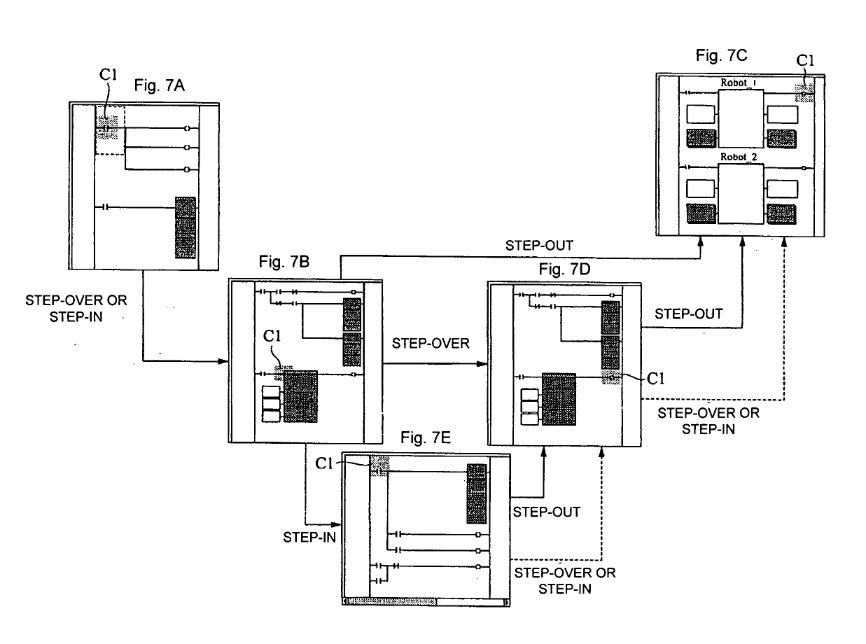

For the processes for the above described function block, if the function block is described in the function block, similar processes are performed for the relevant interior function block. Thus, as shown in FIG. 7A, for example, the steps of the inside of the function block are executed one step at a time through the execution of the step-over/step-in, and the process proceeds to the function block (child) in the function block (parent) (see FIG. 7B). When the step-out button B3 is pushed at this stage, as it is before entering inside the function block (child), the remaining steps (including function (child)) of the function block (parent) is continuously executed and the process proceeds to the next step of the function block (parent), as shown in FIG. 7C.

When the step-over button B2 is pushed in the state of FIG. 7B, the function (child) is continuously executed, and the process proceeds to the next step of the function block (parent) (see FIG. 7D). When the step-in button B1 is pushed in the state of FIG. 7B, the process enters the function (child) and proceeds to the step at the beginning (see FIG. 7E). Similar processes as the normal function block are performed for the internal program of the function block (child). That is, execution is made one step at a time through the execution of the step over/step in, the remaining steps of the function block (child) are continuously executed through the execution of step-out, and the process proceeds to the next step of the function block (parent) (see FIG. 7D). The execution of the step-over/step-in is repeatedly performed, and the process proceeds to the step after the function block execution on the function block calling side after the execution of the final step inside the function block, (see FIG. 7E→FIG. 7D, FIG. 7D→FIG. 7E).

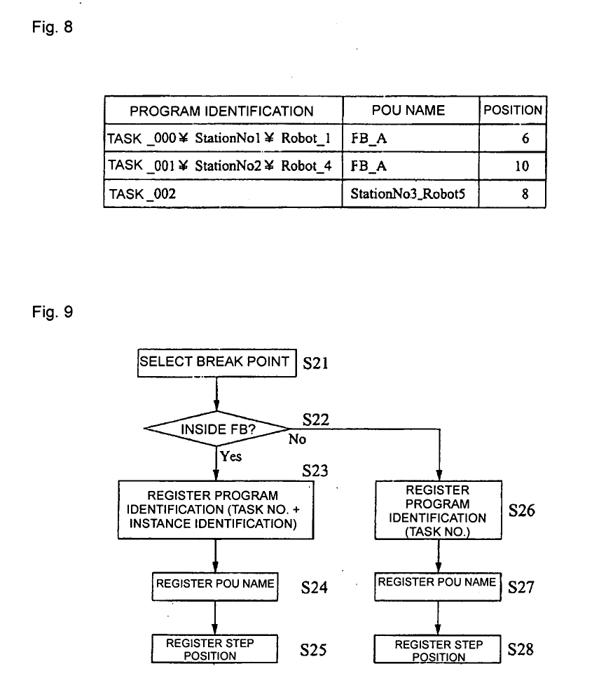

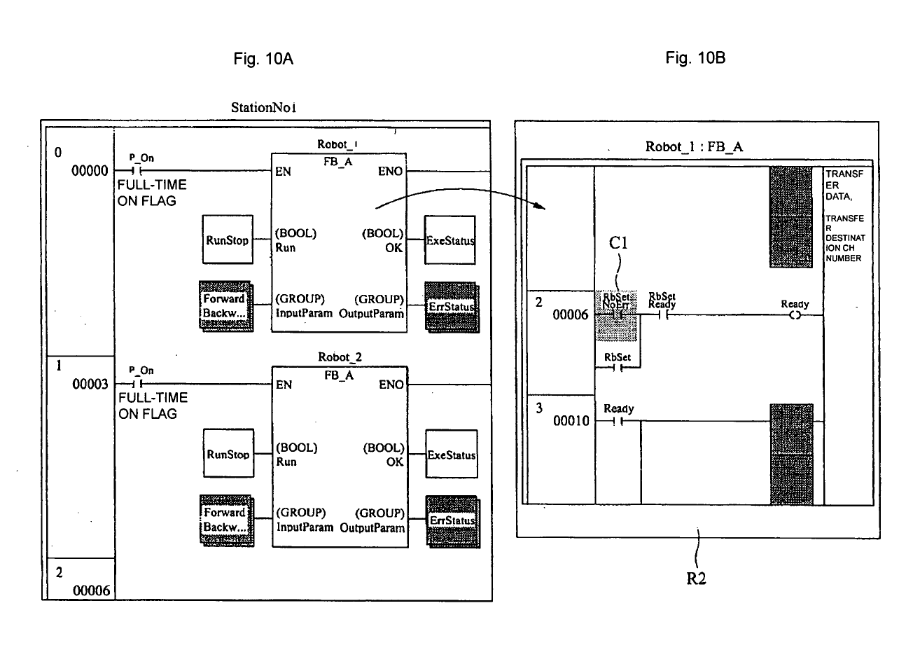

FIG. 8 shows one example of the data structure of the brake point management table stored in the program control information region 15. The brake point management table is a table associating the program identification information, the POU name, and the brake point position (step position of program). As apparent from the project tree displayed in the project tree display region R1 of FIG. 2, the same function block (FB_A) is used at a total of four locations of two (Robot_1 and Robot_2) at task_000 and two (Robot_3 and Robot_4) at task_001.

Briefly, if the brake point is set at the step position of the program itself of the function block (FB_A), the process brakes and stops at the same step position in all four instances. However, a request is actually made to brake and stop in Robot_1 and Robot_4 but to continuously execute without braking in Robot_2 and Robot_3. Furthermore, a request may be made to stop at different step positions in Robot_1 and Robot_4 desired to break the process. This is because, since the controlling target differs even if the same function block is used, the presence of the necessity of braking for each controlling target or the brake point to be stopped differs (e.g., sixth step of Robot_1 and tenth step of Robot_4).

Therefore, in the present embodiment, the targeting instance is uniquely specified by the program identifying information including the task No. and the instance identifying information. Furthermore, the respective brake point set position is identifiable with respect to the instance of the specific function block by managing the relevant program identifying information and the step position of the program.

The program execution unit 13 determines whether or not the current step position is the step where the process breaks and stops based on the information stored in the brake point management table during the continuous execution of the control program, and executes the step if the step position is not the brake point and performs the process of stopping if the step position is the brake point. Whether or not the step position is the brake point is determined as the brake point with the condition that the program identification, the POU name and the step position match. In other words, if at least one of the program identification, the POU name and the step position differs, the step position is determined as not being the brake point, and the relevant step is executed.

In the case of the brake point management table shown in FIG. 8, the function block (FB_A) of the program identifying information of “task_{—}000\StationNo1\Roobot_{—}1” is stored with the condition of breaking at the sixth step, the function (FB_A) of “task_{—}001\StationNo2\Robot_{—}4” is stored with the condition of braking at the tenth step, and thus the Robot_1 of Station No1 breaks and stops at the sixth step but does not stop at the tenth step. On the other hand, the Robot_4 of Station No2 breaks and stops at the tenth step, but does not stop at the sixth step. Furthermore, the process is continuously executed until the end without braking during the continuous execution of the Robot_2 of Station No1 and the Robot_3 of Station No2 (no stop at sixth step or tenth step).

The registration process of the relevant brake point management table is performed when the program control unit 12 executes the flow chart illustrated in FIG. 9. First, selection (input) of the brake point through the operation unit 11 is waited (S21). Specifically, the setting command of the brake point is received for the command specified with the cursor C1 out of the commands (steps) in the program displayed on the program display region R2. That is, the user operates the input device 1 and moves the cursor C1 to the command (step) to set as the brake point in the displayed program. The input device 1 is operated in this state to provide instruction to register the command pointed by the cursor C1 as the brake point. The relevant instruction may be performed through various methods other than displaying a predetermined registration button on the setting screen and clicking the registration button.

Next, determination is made on whether or not the command (step) specified as the brake point is in the function block (S22). If the command is in the function block, the task No. and the instance identification information are registered in the column of the program identification information (S23), the POU name is registered in the column of the POU name (S24), and the step position (number) is registered in the column of position (S24). The program identification information, the POU name or the step position are provided through the operation unit 11. Which program in the project tree display region R1 the program displayed on the program display region R2 is, is known in correspondence on the debug device side, and thus when the cursor C1 is placed on the arbitrary command (step) of the program, the program identification information or the POU name for the relevant program are recognized by the operation unit 11, and the step position specified by the cursor C1 is also recognized by the operation unit 11. Therefore, the information necessary in registering to the brake point management table are acquired by the program control unit 12 through the operation unit 11. For example, the brake points for the Robot_1 or the Robot_4 shown in FIG. 8 are registered by executing the relevant process.

If the selected brake point is outside the function block, the task No. is registered in the column of the program identification information (S26), the POU name is registered in the column of the POU name (S27), and the step position (number) is registered in the column of position (S28). For example, the brake point for Station No3_Robot 5 shown in FIG. 8 is registered by executing the relevant process.

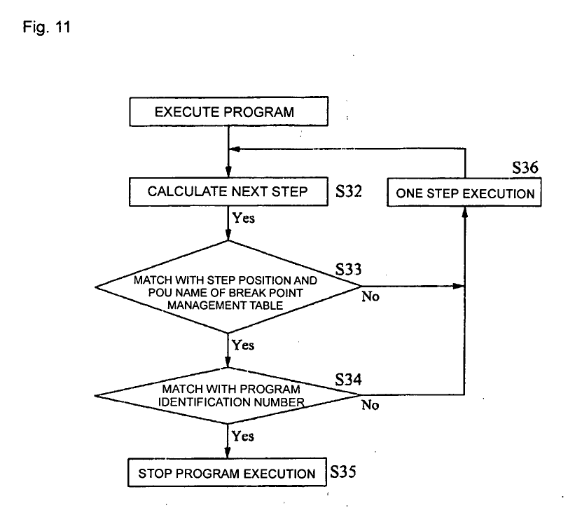

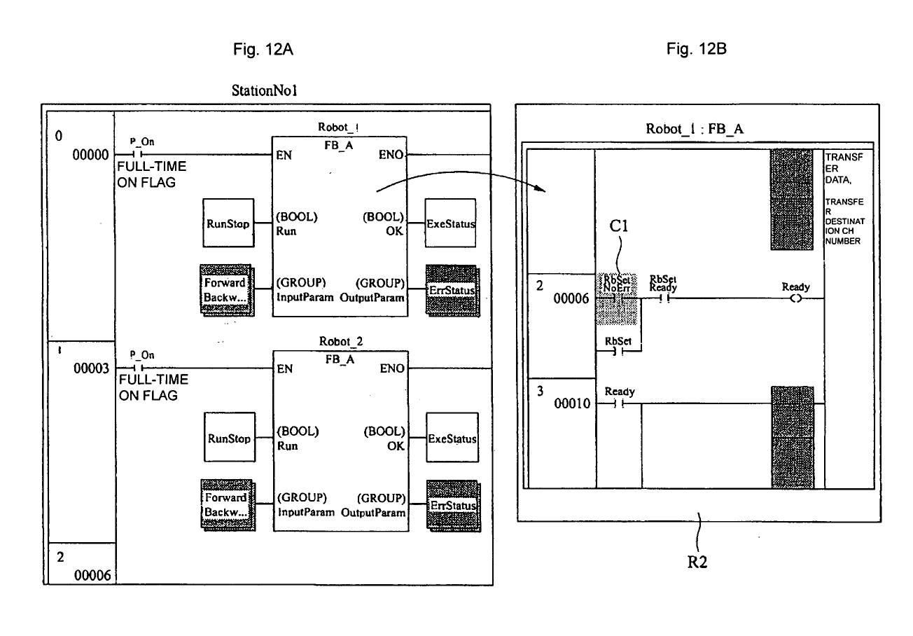

The program execution unit 13 executes the flow chart illustrated in FIG. 11 when the inside of the function block is continuously executed by step-over or step-out. That is, when the continuous execution of the inside of the function block is started, the step to execute next is calculated (S32). Basically, the steps are executed in order of step number, but due to the presence of a jump command etc., the next step number is not necessarily executed, and thus the step to execute next is determined in this processing step.

When the step to executed next is determined, determination is made on whether or not the determined step matches the step position and the POU name registered in the brake point management table (S33). If matched (Yes in S33), determination is made on whether the step matches with the program identifying number (information) (S34). If matched (Yes in S34), determination is made as the brake point and the execution of the program is stopped (S35). If the result is No in either the branched determination of S33 or S34, the step determined in S32 is executed (S36) since the next step is not the brake point. Subsequently, the program returns to the processing step S32, and repeatedly executes the above described processes.

A case of continuously executing the function block of Robot_4 with step-over will now be described by way of an example. In such case, the steps are sequentially executed, and the next step is assumed to be the sixth step. The POU name becomes FB_A and the step position becomes the sixth, which matches the information registered in the brake point management table, and thus the branching determination of the processing step S33 becomes Yes. However, the program identifying information differs, and thus the branching determination of the processing step S34 becomes No and the sixth step is executed.

The process further proceeds, and the next step is assumed to be the tenth step. The POU name is FB_A, the step position becomes the tenth, which match the information registered in the brake point table, and thus the branching determination of the processing step S33 becomes Yes. Since the program identifying information also matches, the branching determination of the processing step S34 also becomes Yes, and thus the program execution is stopped at the relevant stop position.

On the other hand, when the function block of Robot_2 or Robot_3 are continuously executed by step-over, the branching determinations of the processing step S33 become Yes at both the sixth and the tenth step, but the program identifying information does not match, and thus the branching determination of the processing step S34 becomes No, and the program is executed to the final step without being broken. Thus, in the present embodiment, the brake point can be set at a position unique for every instance of each function block.

Although not shown in FIG. 11, if executed to the final step, the program execution for the relevant function block is completed, and thus the process proceeds to the next step of the function program with the process of the step-over or the step-out described above.

Another embodiment of the debug device according to the present invention will now be described.

The debug device may also perform continuous execution. The program execution unit 13 continuously executes the control program from the beginning to the end only once (one scan) and then stops when acquiring the fact that the one scan execution operation button B4 has been pushed from the operation unit 11 via the program control unit 12. The program execution unit 13 repeatedly executes the control program when acquiring the fact that the continuous execution operation button B5 has been pushed from the operation unit 11 via the program control unit 12. Furthermore, the program execution unit 13 stops the program execution at the step position at the beginning of the control program when recognizing that the execution stop button B6 has been pushed during the repeated execution of the control program. In reality, determination is made on whether or not the execution stop button B6 has been pushed when executing the program to the end of the control program and returning the step to execute to the beginning of the control program, where if the execution stop button B6 has not been pushed, the control program is continuously executed from the beginning to the end and the executing position is returned to the beginning of the control program. Furthermore, when the execution stop button B6 has been pushed when the step to execute is returned to the beginning of the control program, the execution of the program is stopped. Therefore, the execution stop button B6 effectively functions when the continuous execution button B5 has been pushed and the control program is being repeatedly executed, and normally, is an inactive button as shown in FIG. 2 and cannot be selected. The execution stop button B6 becomes active on the condition that the continuous execution button B5 is pushed.

If the brake point is set and registered in the program control information region 15, the program execution unit 13 determines whether or not the next executing position is the step position set as the brake point during the continuous execution, and executes the relevant step if the relevant position is not the brake point and suspends the execution of the program if the relevant position is the step position of the brake point. In the present embodiment as well, the data structure of the brake point management table stored in the program control information region 15 is adopted, similar to FIG. 8. The specific description will be redundant and thus will be omitted.

The registration process of the relevant brake point management tale may be performed when the program control unit 12 is executed similar to the flow chart illustrated in FIG. 12. The specific description will be redundant and thus will be omitted.

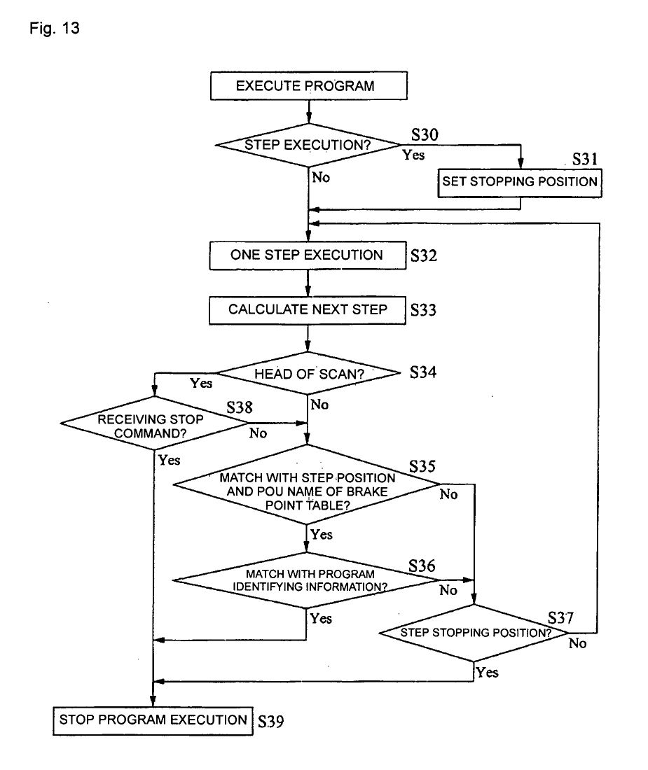

In this embodiment, the program execution unit 13 performs execution and stop of the program with reference to the brake point management table created by the above described registration process in executing the control program. Specifically, the program execution unit 13 executes the flow chart illustrated in FIG. 13.

First, determination is made on whether or not the execution is a step execution (S30). The step execution is when the continuous execution involved in pushing either the one scan execution operation button B4 or the continuous execution operation button B5 is not performed in the operation screen shown in FIG. 2. In the case of the step execution, the process for setting the stop position is performed (S31). In the process of setting the stop position, the stop position is set to the step to execute next after the one step execution in case of the one step execution. In case of the step-over execution, the stop position is set to the next step of the function block (similar to S16 of FIG. 6).

The continuous execution is performed when the one scan execution operation button B4 or the continuous execution operation button B5 is pushed, and thus the branching determination of the processing step S30 becomes No, whereby S31 is not performed and thus the stop position is not set.

The program execution unit 13 executes the step of the current executing position (S32). The program execution unit 13 then calculates the step to execute next (S33). Basically, the steps are executed in the order of step numbers, but due to the presence of a jump command etc., the step is not necessarily executed in order, and thus the step to execute next is determined in this processing step.

When the step to execute next is determined, the program execution unit 13 determines whether or not the determined step is the step at the beginning of the scan (beginning of control program) (S34). If the step is not at the beginning (branching determination of processing step S34 is No), determination is made on whether or not the next executing position (step) determined in S33 matches the step position and the POU name registered in the brake point management table (S35). If match is found (branching determination of processing step S35 is Yes), determination is made on whether or not match is found with the program identifying number (information) (S36). If the match is found (branching determination of processing step S36 is Yes), the next step that is to be currently executed is determined as the break point and the execution of the program is stopped (S39). If the result is No in either branching determination of the processing step S35 or the processing step S36, the next step is not determined as the break point, and thus the process jumps to the processing step S37. In the processing step S37, determination is made on whether or not the next step that is to be currently executed is the step stopping position set in S31 (S37). If the step is the step stopping position (Yes in branching determination of processing step S37), the execution of the program is stopped (S39). If the step is not the step stopping position (No in branching determination of processing step S37), the processing step S32 is executed.

If the step obtained in the processing step S33 is the beginning of the control program, on the other hand, the branching determination of the processing step S34 becomes Yes, and thus determination is made on whether or not the stop command is being received (S37). Specifically, determination is made on whether or not the execution stop button B6 has been pushed (received). If the stop command is not being received, the process jumps to the processing step S35.

According to such flow chart, in case of the one step execution, if one step is executed in the processing step S32, the next step is the step stopping position, whereby the processing step S37 becomes Yes and the program execution is stopped. That is, the program is executed only by one step and then stopped. In a case of the step-over execution, the process proceeds in order from the processing steps S32 to S35, and the processing step S35 becomes No, No if no break point is reached, and the processing step S37 also becomes No, No as long as the steps are remaining in the function block, and thus the process returns to the processing step S32 and repeats the same. If the break point is not present, after repeating S32 to S37 as described above and processing all the steps in the function block, the step stop position set in S31 is reached, whereby S37 becomes Yes and the program execution is stopped. That is, the process stops after executing all the remaining steps in the function block. If the break point is present, the processing step S35 and S36 become Yes in the one step execution and in the step-over execution, whereby the program execution stops at the position of the break point (S39).

If the one scan execution operation button B4 or the continuous execution operation button B5 is pushed and executed, the process proceeds in order from the processing step S32 to S35 if not at the beginning of the scan, and the processing step S35 becomes No, No if the break point is not reached, and the processing step S37 becomes No, No since the stopping position is not set, whereby the process returns to the processing step S32 and repeats the same. If the break point is present, the processing steps S35 and S36 become Yes, and the program execution stops at the position of the break point (S39). That is, in case of the continuous execution, the above described S32 to S37 are repeatedly executed unless the break point is reached or the execution stop button b6 is pushed. If the execution stop button B6 is pushed during the continuous execution, and the stop command is received, S34 becomes Yes at the position of the beginning of the scan, S38 becomes Yes and the program execution is stopped.

In the case of the one scan execution, the process proceeds through the processing steps S32 to S35 in order if not at the beginning of the scan, and the processing step S35 becomes No, No unless the break point is reached and the processing step S37 becomes No, and the process returns to the processing step S32. This flow is repeated as long as the program in one scan is remaining. If the break point is present, the program execution is stopped at the position of the break point in the processes of the processing steps S35 and S36 (S39). When the process returns to the beginning of the scan after processing all the steps of the program in one scan even if the break point is not present, S34 becomes Yes, ST 38 becomes Yes and the program execution is stopped (S39). In addition, such operation is realized by automatically issuing the stop command irrespective of the operation of the execution stop button B6 when the one scan execution operation button B4 is pushed. Two determinations of “receive stop command?” and “one scan execution?” may be made in the processing step ST38 without automatically issuing the stop command with the pushing of the one scan execution operation button B4. The two determining processes may be divided so as to become serial flow processes.

In the flow chart of FIG. 13, modification may be made so that the one scan execution is handled as the step execution in the processing step S30. In this case, the processing step S30 becomes Yes, and the stop position is set to the step at the beginning of the scan in the processing step S31. According to this variant, in the case of the one scan execution, S34 becomes Yes when the position of the beginning of the scan is reached, but ST38 becomes No, No, and after the processes of ST35 and ST36, ST37 becomes Yes as match is found with the step stop position set in ST31, and the program execution is stopped (S39).

A case of continuously executing the inside of the function block of Robot_4 will now be described by way of example (this is different form continuous execution by step-over described above). In this case, assumption is made that the steps are sequentially executed, and the next step is the sixth step. The POU name is FB_A and the step position is the sixth, which matches the information registered in the brake point management table, and thus the branching determination of the processing step S35 becomes Yes. However, since the program identifying information is different, the branching determination of the processing step S36 becomes No, and the sixth step is executed.

The process further proceeds, and the next step is assumed to be the tenth step. The POU name is FB_A and the step position is the tenth, which matches the information registered in the break point management table, and thus the branching determination of the processing step S35 becomes Yes. Furthermore, the program identifying information also match, and thus the branching determination of the step S36 also becomes Yes, and the program execution stops at the relevant step position.

When the function blocks of Robot_2 or Robot_3 are continuously executed by step-over, the branching determination of the processing step S35 becomes Yes at the sixth and the tenth step, but since the program identifying information does not match, the branching determination of the processing step S36 becomes No, and the process is executed until the last step without being broken. Thus, in the present embodiment, the break point can be set at a position unique for every instance of each function block.

The present embodiment may obviously perform suspension based on the brake process with similar procedures with respect to the break point set for the normal command (step) outside the function block.

What is claimed is:

1. A debug device for a control program including a function block; the debug device comprising:
a one step executing section for executing each step configuring the control program one step at a time;
a step-over executing section for executing a step-over of continuously executing a program in the function block, and moving a next executing position to the step after an execution of the program in the function block in the control program when the next executing position by the one step executing section is the function block; and
a step-in executing section for executing a step-in of having the head position of the program in the function block as the next executing position when the next executing position by the one step executing section is the function block.

2. The debug device according to claim 1, further comprising a step-out executing section for executing a step out of continuously executing from the next executing position to the end of the function block and moving the next executing position to the step after an execution of the function block when the next executing position by the one step executing section is the step of the program in the function block.

3. The debug device according to claim 1, wherein the control program is a program of layered structure with a function block (child) described in the function block; and
the program in the function block is executed one step at a time by the one step executing section, and when the next executing position is the function block (child), the head position of the program in the function block (child) is set as the next executing position and the function block (child) is one step executed when the step-in executing section is operated.

4. The debug device according to claim 2, wherein the control program is a program of layered structure with a function block (child) described in the function block; and
the program in the function block is executed one step at a time by the one step executing section, and when the next executing position is the function block (child), the head position of the program in the function block (child) is set as the next executing position and the function block (child) is one step executed when the step-in executing section is operated; and
when the next position by the one step executing section is the step of the program in the function block (child), a continuous execution is performed from the next executing position to the end of the function block (child), and the next executing position is moved to the step after the execution of the function block (child) in the program of the function block when the step-out executing section is operated,.

5. The debug device according to claim 1, wherein the control program is a program of layered structure with a function block (child) described in the function block; and
the program in the function block is executed one step at a time by the one step executing section, and when the next executing position is the function block (child), the program in the function block (child) is continuously executed, and the next executing position is moved to the step after the execution of the function block (child) in the function block when the step-over executing section is operated.

6. The debug device according to claim 1, further comprising:
a storage section for storing break point management information associating program identifying information for specifying the function block described in the control program, and the step position information for suspension in the program in the function block; and
a suspension section for determining whether or not the currently executing step is the step position of the function block specified with the break point management information stored in the storage section during the continuous execution of the function block, and suspending the program execution when relevant.

7. The debug device according to claim 6, wherein the program identifying information includes instance identifying information of the function block.

8. A debug device for a control program including a function block; the debug device comprising:
a program executing section for continuously executing steps configuring the control program;
a storage section for storing break point management information associating program identifying information for specifying the function block described in the control program and step position information for suspension in the program in the function block; and
a suspension section for determining whether or not the currently executing step is the step position of the function block specified with the break point management information stored in the storage section during a continuous execution of the function block by the program executing section, and suspending the program execution when relevant.

9. The debug device according to claim 8, wherein the program identifying information contains instance identifying information of the function block.

10. The debug device according to claim 8, wherein the storage section stores break point management information associating, with respect to a step outside the function block, program identifying information for specifying the step and the step position of the step; and
the suspension section suspends the program execution when relevant for the step outside the function block.
